(19) United States
(12) Patent Application Publication
(10) Pub. No.: US 2003/0116693 A1
(43) Pub. Date: Jun. 26, 2003

(54) Device for the alumino-thermic welding of two ends of a rail

(76) Inventors: Jan Hantusch, Essen (DE); Michael Steinhorst, Essen (DE); Frank Kuster, Ratingen (DE); Ron Moller, Matcham (AU)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/257,882

(22) PCT Filed: Apr. 4, 2001
(86) PCT No.: PCT/EP01/03801

(30) Foreign Application Priority Data
Apr. 17, 2000 (DE) 20006983.7

(51) Int. Cl. B23K 23/00

(52) U.S. Cl. 249/86; 164/54

(57) ABSTRACT

Device for the alumino-thermic welding of two ends of a rail A device for the alumino-thermic welding of two ends of a rail, namely a casting mould (4) which is open on the upperside and which comprises a central casting chamber which is defined by the rail ends, which are spaced apart from each other by a welding groove (3), and also by the walls of the casting mould (4) and to the side of the casting chamber said casting mould comprises at least one riser (13) which is permeably connected to the casting chamber only in the region of the rail foot (11), and wherein a reaction pot (1) is provided on the base side with an outflow device which causes a steel melt to flow out of the reaction pot (1) and into the casting mould (4), is configured substantially to obviate turbulent flow conditions inside the casting mould and to homogenise the solidification of an intermediate cast structure between the ends of the rail such that the steel issuing out of the reaction pot (1) after the completion of an alumino-thermic reaction and after the separation of the steel and slag issues directly into the casting chamber in the form of a top casting and issues into the at least one riser (13) in the form of a bottom casting simultaneously. On the whole, these measures lead to a welding result which is improved in terms of quality in comparison with the prior art and which is free of any casting or structural errors.

The invention relates to a device according to the preamble of claim 1.

The alumino-thermic welding of two ends of a rail, in particular in laid track work is viewed for practical reasons as being particularly advantageous, in particular with regard to the type of energy required for generating a molten welding material. The reason for this is that this energy is obtained exclusively by way of a chemical reaction. In order to perform a welding process, the ends of a rail which are spaced apart from each other by a welding groove are inserted into a casting mould which symmetrically covers this welding groove, wherein above the casting mould a reaction pot is fixed in a particular holding device and is closed on the base-side initially by means of a fusible element and at the beginning of the welding process is filled with an alumino-thermic welding portion. This consists of a fine-grain mixture, the essential components of which are aluminium and iron oxide, to which alloy elements are added where appropriate, in order to provide specific metallurgical properties of the welding material structure which are adapted to suit the properties of the rails which are to be connected. The alumino-thermic mixture can be ignited, for example, by means of a small ignition rod or another ignition source, whereupon the reaction triggered thereby causes a reduction in the iron oxide and oxidation of the aluminium, in particular to form a steel melt, on which the floats the slag which consists substantially of aluminium oxide.

Upon separation of the melt and slag, the fusible element which closes the base-side orifice of the pot is melted, whereupon the steel melt is introduced into the casting mould.

The intermediate cast region formed by virtue of the melt between the ends of the rail inside the casting mould finally solidifies and forms the welding material structure.

It is known that the quality of the welding connection produced in this manner is influenced by numerous factors, wherein the factors referred to merely by way of example are the duration and intensity of the preheating of the ends of the rail, alloy elements which are contained in the melt, the type of casting process and the manner in which the flow of the melt is conducted inside the casting mould. The rate of the casting procedure in relation to the non-uniform cooling of the intermediate cast region, which occurs immediately upon commencement of the pouring-in procedure, and the associated non-uniform structure formation also represents a significant factor. For example, it is necessary to prevent those cooling and solidification ratios, in which molten regions are surrounded by an already solidified structure, since this causes bubbles, pores and the like. Furthermore, turbulent flow conditions should be obviated inside the casting chamber of the casting mould as should the formation of spatters. Finally, the temperature of the melt flowing into the casting mould must ideally be arranged to correspond with the duration of the pouring-in procedure and the preheating such that sufficient heat is introduced into the casting mould, and furthermore particularly at the points at which solidification commences relatively more quickly as a result of considerable cooling and a low accumulation of matter.

In order to introduce the steel melt into the casting mould, essentially two casting processes are known, in particular those configured in the form of a bottom casting and in the form of a top casting. An essential feature of the top casting is that at the upperside the steel melt falls into the casting chamber including the weld groove, forms a melting bath in the region of the foot of the rail, in order as a consequence to rise simultaneously in the casting chamber and in the risers attached to the foot of the rail. This type of casting process is disclosed, for example, in DE 42 31 064 A1.

Furthermore, casting processes are known which are configured in the form of a bottom casting. An essential feature of these casting processes is that the steel melt is introduced into the casting chamber by way of one or both of the risers extending laterally with respect to the casting chamber, so that the melt issuing into the casting chamber in the region of the foot of the rail fills said chamber progressively from the bottom upwards.

Both of these known casting processes have their respective drawbacks. Therefore, the top casting process is characterised according to the flow-guidance within the casting mould by substantially turbulent flow conditions caused by numerous edges.

In contrast thereto, although the bottom casting process is characterised by a relatively uniform, yet less-turbulent flow-guidance within the casting mould—as a result of the comparatively long flow paths, starting from the inlet into a riser to the region of the rail head—significant cooling is, however, achieved. For this reason, this casting process generally requires careful preheating in particular of the rail cross-piece and rail head.

Against this background, it is the object of the invention to provide a device of the type described in the introduction, wherein the solidification of the intermediate cast structure between the ends of the rail is homogenised whilst substantially obviating turbulent flow conditions and the associated damaging effects. In the case of a device of this type, this object is achieved by the features of the characterising part of claim 1.

Accordingly, it is an essential feature of the invention that in contrast to the prior art set forth in the introduction the casting mould and/or the reaction pot is/are arranged with the proviso that a casting process is provided which is performed simultaneously in the form of a bottom casting and a top casting. The steel melt provided in the reaction pot thus enters into the casting chamber simultaneously by way of the upper and lower end of the casting chamber. It has been noted that in this manner the disadvantages of the bottom casting, namely the relatively cooler rail head portion, and of the top casting, namely the tendency for turbulent flow conditions to form, can be reduced considerably. Immediately upon commencement of the pouring-in procedure the two portions of the steel melt which are introduced in the form of a bottom and top casting respectively are mixed thoroughly in the region of the foot of the rail. This and the follow-up of melt and heat, which continues during the further pouring-in procedure, on the one hand in a central upper region of the casting chamber and on the other hand in a peripheral lower region of the casting chamber brings about an intensive heat exchange and homogenisation of the cooling and solidification conditions which is particularly noticeable at the critical points of the foot of the rail and of the transition between the foot of the rail and the cross-piece and between the cross-piece and the rail head. On the whole, the welding result is improved in terms of quality and is free of casting and structural errors.

In general, where the casting procedure involves the bottom casting, the casting procedure is performed symmetrically with respect to a longitudinal middle plane of the ends of the rail, thus by way of at least two risers on both sides of the rails. However, asymmetrical pouring using merely one riser is also possible.

In accordance with the features of claims 2 to 5, a reaction pot which is known per se is used which comprises on the base-side an outflow orifice, into which is inserted a pot stopper or a comparable closure body which is intended for at least partial melting and which serves initially to close the reaction pot. The casting mould is provided in a manner which is know per se with a bar, a component whose purpose is to absorb the kinetic energy of the steel melt issuing into the casting mould in free fall from the upperside and to distribute this steel melt in the form of two partial flows—in a plane perpendicular to the rail longitudinal direction—in a lateral manner with respect to a longitudinal middle plane of the end of the rail. One inventive embodiment of the casting mould includes a flow divider whose purpose is to divide each of the two partial flows once again, and furthermore into a first portion introduced from the upperside directly into the casting chamber, and into a second portion introduced initially into the riser and then introduced via said riser in the region of the foot of the rail into the casting chamber from the lower side. This type of flow divider can be structured in basically any manner. It is merely essential that each partial flow is divided into the said two portions in a manner which can be specified preferably in terms of quantity.

In general, the bar is placed relative to the steel melt impinging thereon, such that the steel melt impinges upon the middle of the bar. However, it is equally possible for the steel melt to impinge upon the bar off-centre. In a particularly advantageous manner, the upperside of the bar can be formed with a view to exerting a guiding action upon the steel melt, e.g. by virtue of the fact that starting from the region in which the steel melt impinges upon the bar the surfaces of the bar are inclined in the direction of desired flow.

The application of the subject matter of the invention is not dependent upon the existence of the said bar. This function can also be accomplished structurally in a different manner. It is merely essential that the casting mould is arranged for producing the said two portions in the form of a top casting and a bottom casting.

The features of claims 6 and 7 are directed to one possible structural embodiment of the flow divider.

The features of claims 7 and 8 are directed to the structural parameters of a flow divider which determine the quantity ratio of the two portions of the steel melt according to claims 6 and 7. In this case, it is assumed that the partial flow of the steel melt which is guided starting from the bar under the influence of gravity is divided substantially according to an effective surface ratio of two cross-sections, namely the inlet cross-sections of the connection lines leading on the one hand to the riser and on the other hand leading into the casting chamber on the upperside.

The features of claims 10 to 12 are directed to an alternative embodiment of a casting mould. In this case, it is essential that the bar itself partly assumes the function of a flow divider to the extent that in this case it is generally arranged such that the steel melt is subdivided into four partial flows, of which in each case two are directed away from each other in the longitudinal direction of the rail and two are in turn directed away from each other transversely with respect to the longitudinal direction of the rail. The partial flows which are guided in the longitudinal direction of the rail are intended for introduction into the upper part of the casting chamber, whereas the two other partial flows are intended for introduction into the upper ends of two risers which are placed laterally with respect to the casting chamber.

A casting procedure which is symmetrical with respect to a longitudinal middle plane of the rail ends and a transverse middle plane of the casting chamber is generally preferred—an asymmetrical solution in which e.g. only one riser is used within the framework of the bottom casting is, however, equally possible.

By way of a recess in the upperside of the bar according to the features of claim 13, which recess functions as the primary receptacle for the steel melt which issues in free fall out of the reaction pot, it is also possible to assist the formation of calm flow ratios within the casting mould. In this case, the melt initially fills this recess and its overflow is consequently divided up in the form of a bottom casting and top casting.

The features of claims 14 and 15 are directed to basic alternatives of forming the bar. This is generally designed as a component which is separate from the casting mould and which is inserted merely loosely therein. It is advantageous to remove the bar during preheating of the casting mould. However, the bar can equally also form an integral part of the casting mould, as it is equally also possible to implement the preheating by way of the riser(s). For example, the bar can be divided in the middle, so that one half of the bar is fixedly connected to each of the two casting mould halves.

The features of claims 16 and 17 relate to an alternative embodiment of the subject matter of the invention which differs from the one described above in that a conventional casting mould is now used and the reaction pot has been adapted to suit the subject matter of the invention. However, the purpose of this adaptation is to introduce the steel melt, which is formed as a result of the alumino-thermic reaction, at the same time in the riser(s) on the one hand and in the upper region of the casting chamber, so that in turn a casting process is provided which is performed simultaneously in the manner of a bottom casting and top casting. It is essential for this embodiment that all of the outflow orifices of the reaction pot open simultaneously.

The invention will be explained in detail hereinunder with reference to the exemplified embodiments illustrated schematically in the drawings, in which

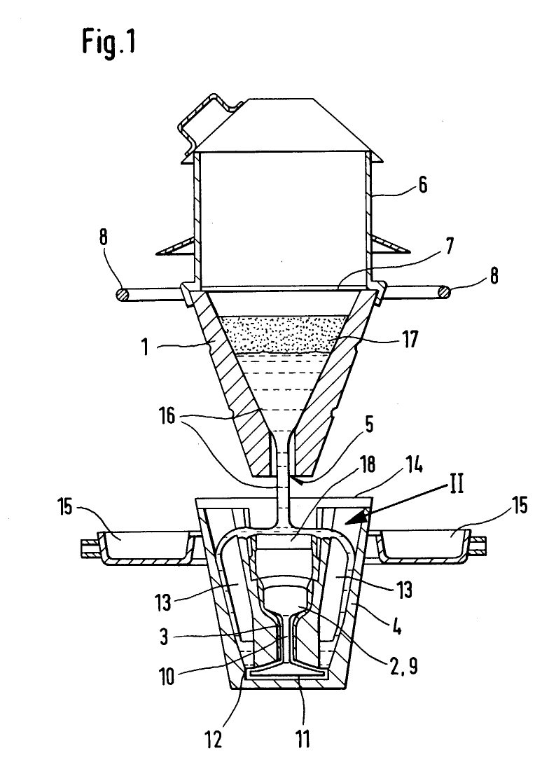

FIG. 1 shows a partially vertical sectional view of a device in accordance with the invention for welding two ends of a rail;

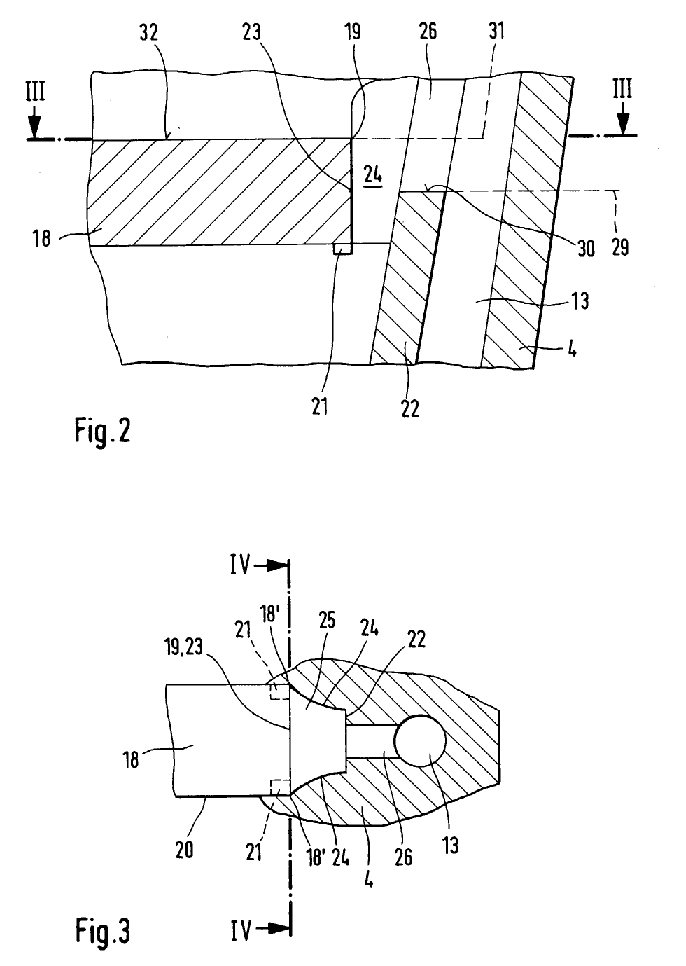

FIG. 2 shows an enlarged partial illustration of a region II of FIG. 1 in a vertical sectional view;

FIG. 3 shows a view according to a sectional plane III-III in FIG. 2;

FIG. 4 shows a partial illustration of a view according to a sectional plane IV-IV in FIG. 3;

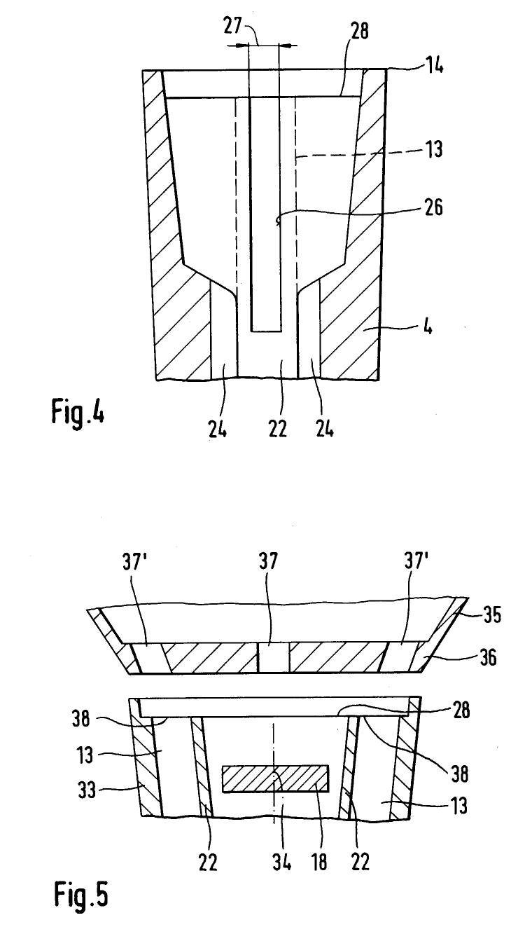

FIG. 5 shows an alternative embodiment of a device in accordance with the invention in a partial view according to a vertical sectional plane similar to the one in FIG. 1.

In FIG. 1, the reference numeral 1 designates a reaction pot which is accommodated above two rail ends 2, which are to be connected together by means of intermediate cast welding, in a holding device [not illustrated in the drawing]. The rail ends 2 which are to be connected are spaced apart from each other on the end side by a welding groove 3, wherein the welding groove is located inside a casting mould 4 which is composed of two mould halves. The two mould halves of the casting mould which are configured in a mirror-inverted manner with respect to each other are attached laterally to the rail ends to be connected and extend symmetrically on both sides of the welding groove 3. They are affixed to each other in a manner which is not illustrated in the drawing. The casting mould 4 which is also formed in a manner known per se from a refractory material encompasses a casting chamber which is defined perpendicularly to the plane of the drawing in FIG. 1 by the end sides of the rail ends 2 to be connected and is defined on the lower side and laterally by means of the walls of the casting mould 4 which face the welding groove 3.

The reaction pot 1 is held above the casting mould 4 with the proviso that its outflow orifice 5 is located in a central region above the welding groove 3. A cover hood 6 whose purpose shall be explained hereinunder is attached to the upper edge 7 of the reaction pot 1 and forms the upperside end of the device. The reference numeral 8 designates diametrically opposed handles which are attached in the region of the upper edge 7 and are intended for transporting the reaction pot 1.

As shown in the illustration in FIG. 1, the profile of the rail ends which are to be connected is characterised by a rail head 9, a cross-piece 10 and a rail foot 11, wherein in the region of the rail foot 11, and in particular on its upper-side lateral extremities 12, the inlet orifices of two risers 13 are located, of which the longitudinal axes extend within a plane extending perpendicularly with respect to a longitudinal middle plane of the rail ends 2 which are to be connected, and furthermore such that the two risers 13 form an approximately V-shaped configuration with respect to the said longitudinal middle plane. The upperside end 14 of the casting chamber 4 and in particular the upperside inlet orifices of the risers 13 are open.

The reference numeral 15 designates slag trays which in proximity to the said upper end 14 are attached to the casting mould 4 and whose purpose will also be explained hereinunder.

In order to produce a welding connection between two rail ends 2 by intermediate casting, the casting mould 4 is initially placed in a symmetrical arrangement with respect to the welding groove 3 and the casting chamber, in particular any gaps between the mould halves on the one hand and the rail ends on the other hand, is sealed e.g. by foundry sand. Subsequently, using the holding device stated in the introduction the reaction pot 1 is placed above the welding groove 3, wherein the said reaction pot contains a fine-grain alumino-thermic mixture, whose substantial components are aluminium on one hand and iron oxide on the other.

In this phase, the outflow orifice 5 of the reaction pot 1 is closed by virtue of a pot stopper [not illustrated in the drawing] or by a fusible element comparable thereto in terms of function. It is essential for the fusible element or the pot stopper to be closure bodies which under the effects of heat open the outlet orifice 5 after a defined period of time has lapsed.

The alumino-thermic mixture inside the reaction pot 1 is consequently ignited for example by means of a small ignition rod or other ignition device and in this manner the alumino-thermic reaction is initiated. Following on immediately from this, the cover hood 6 is placed on to the reaction pot 1.

The alumino-thermic reaction performed subsequently leads to a reduction in the iron oxide and ultimately to the formation of slag 17 which floats on the molten steel 16. The purpose of the cover hood 6 in this reaction phase is mainly to prevent molten steel from being ejected in an uncontrolled manner in particular in the case of a volatile reaction. In this respect, it acts merely as a protective device which affords protection to the immediate surrounding area of the weld point.

As soon as the alumino-thermic reaction has come to an end, i.e. as soon as the melt and slag have separated owing to the difference in density, the outflow orifice 5 is opened and the closure member located at this site is formed such that the period of time which lapses until the point of opening due to melting is sufficient to allow the alumino-thermic reaction to take place including the separation of steel and slag inside the reaction pot 1.

At the point in time the closure body melts, molten steel issues out of the outflow orifice 5 and into the casting mould 4 by way of the upperside open end 14.

In addition, reference is made hereinunder to the illustrations of FIGS. 2 to 4.

The reference numeral 18 designates a bar, in this case an approximately square component which is formed form the same material as the casting mould 4 and is located inside the casting chamber stated in the introduction at a spaced interval above the rail head 9 in proximity to the upper end 14. The bar 18 extends transversely with respect to the rail longitudinal direction and symmetrically with respect to a common longitudinal middle plane of the two rail ends 2. The bar 18 is also dimensioned in relation to the passage cross-section of the casting chamber of the casting mould 4 in its central region such that the molten steel which—as indicated schematically in FIG. 1—impinges centrally upon the upperside of the bar 18 can flow off symmetrically in both lateral directions, so that the steel flows off substantially only via the narrow sides 19 and not via the longitudinal sides 20 of the bar 18. The bar 18 is supported in the illustrated position by virtue of the fact that it lies on four brackets 21 which are intended to engage under the lower-side corners of the bar 18 and which are integrally formed on the facing walls of the casting mould 4.

The reference numeral 22 designates the casting chamber wall which lies opposite the vertical end side 23 of the bar 18 in the plane of the drawing of FIG. 3 and which is inclined towards the underside of the casting mould 4 and towards the longitudinal middle plane thereof. The said wall 22 is adjoined—when viewed symmetrically with respect to a vertical longitudinal middle plane of the bar 18—by convexly curved run-up walls 24 which extend vertically and furthermore substantially adjoin the lateral vertical edges 18′ of the bar 18. The run-up walls 24, the end side 23 and the wall 22 define a substantially vertical passage 25 which leads into the casting chamber. What is essential for this passage 25 is the arrangement of the wall 22 which is inclined towards the longitudinal middle plane of the rails and whose significance will be discussed hereinunder.

The reference numeral 26 designates an elongated, in cross-section approximately rectangular recess in the wall 22 which serves to provide a connection between the passage 25 on the one hand and the riser 13 on the other hand. The width 27 of this recess is dimensioned in the drawing by way of example to be smaller than the diameter of the riser 13 and in particular smaller than the width of the bar 18 as seen in the plane of the drawing in FIG. 3. However, this should be understood as merely an example.

As shown in FIG. 4, the recess 26 extends to an upper free edge 28 in the proximity of the upper end of the casting mould 4. This should also be understood as merely an example.

The plane 29 of the underside 30 of the recess 26 is located below the plane 31 of the upperside 32 of the bar 18. It is essential here that the difference in height of the planes 29, 31 in conjunction with the cross-sectional dimension of the recess 26 and the cross-section of the passage 25 are dimensioned such that the molten steel which in FIG. 1 impinges centrally upon the bar 18 and of which half is deflected to the right-hand side and half to the left-hand side, as seen with respect to the rail longitudinal direction, passes according to a defined parts ratio on the one hand via the passage 25 into the casting chamber in the form of a top casting and on the other hand passes via the recess 26 and the riser 13 in the region of the foot of the rail in the form of a bottom casting into the casting chamber. In order to structurally dimension this parts ratio, the parameters available include the geometry of the passage 25, the dimension and arrangement of the recess 26, in particular relative to the width of the bar 18, the cross-sectional areas of the passage 25 and of the recess 26 and the spatial arrangement of the passage 25 and of the recess 26 relative to the bar 18.

It is essential that by reason of the combination of the top casting and the bottom casting such a melting bath forms primarily in the region of the foot of the rail, which melting bath is supplied with melt and heat on the one hand in a central region, namely via the welding groove and on the other hand via the region of the outer extremities, namely via the risers, so that at critical points where increased heat dissipation and premature solidification are to be expected, there is always sufficient heat available which on the whole will help suppress the formation of those zones, in which molten portions are surrounded by an already solidified structure. Furthermore, formed prematurely in the region of the foot of the rail is a melting bath, within which the melt portions introduced into the casting chamber in each case via the risers on the one hand and via the welding groove on the other hand are mixed thoroughly, wherein, however, the occurrence of turbulence is damped and the formation of metal spatters obviated.

The suppression of turbulence is also assisted substantially by the uniform flow of the melt along the inner side of the walls 22, by means of which it is possible to obviate any free fall of the melt and to guide the melt in a substantially ordered manner into the region of the melting bath located initially on the base-side.

Within the framework of the above-described exemplified embodiment of a device in accordance with the invention, a conventional reaction pot was used, wherein the casting mould has been modified with regard to the provision of a casting process of this type which is configured in the manner of a top casting and a bottom casting. As an alternative to this, it is also possible to use a conventional casting mould and to form the outlet of the reaction pot, in particular its base region, in such a manner that in conjunction with specific dimensions of the casting mould after tapping of the reaction pot a casting process is performed which is characterised by the simultaneous top and bottom casting. For this purpose, reference is made hereinunder to FIG. 5 of the drawing.

FIG. 5 illustrates a casting mould 33 which differs from the one in the preceding exemplified embodiment in that a recess 26 is not provided and consequently the walls 22 of the casting chamber are formed in a closed manner as far as into the region of the upper edge 28. The risers 13 are formed in an identical manner and arranged in the manner of those in the preceding exemplified embodiment. In this respect, this is a conventional casting mould which is arranged for a top or bottom casting in dependence upon the manner in which the melt is introduced, wherein molten steel impinges upon the middle 34 of the bar 18 and flows off symmetrically towards both sides.

The reference numeral 35 designates a reaction pot which in the same manner as the reaction pot 1 is intended to perform the alumino-thermic reaction but has been specifically adapted on the base-side to suit the casting mould 33. This adaptation serves to provide this type of casting process which is arranged simultaneously in the form of a bottom casting and top casting as in the case of the exemplified embodiment above.

For this purpose, the base 36 of the reaction pot 35 comprises a central outflow orifice 37 and two edge-side outflow orifices 37′. The central outflow orifice 37 is allocated a bore, of which the axis extends perpendicularly with respect to the plane of the base 36 and in particular centrally with respect to the bar 18, so that molten steel issuing out via the outflow orifice 37 would impinge on the middle 34 of the bar 18. The edge-side outflow orifices 37′ are allocated bores, of which the axes extend inwardly and in particular are arranged under the proviso that the molten steel issuing out of these outflow orifices 37′ is guided in the direction of the upperside mouth orifices 38 of the risers 13.

In turn, pot stoppers, fusible elements or closure bodies which operate in a comparable manner are inserted into the outflow orifices 37, 37′ and are mutually arranged such that the opening periods in the case of the closure orifices 37, 37′ turn out to be the same. This means that after performing the alumino-thermic reaction and after the steel melt and the slag have been separated the tapping procedure is performed at the same time in the case of all of the outflow orifices 37, 37′, so that simultaneously the casting mould 33 is charged via the bar 18 in the form of a top casting and is charged via the risers 13 in the form of a bottom casting, wherein in turn the positive effect set forth in the introduction is achieved for the solidification process, namely the adjustment of substantially calm flow conditions.

The system of the edge-side outflow orifices, as illustrated in FIG. 5, in particular the bores allocated thereto in the base 36 merely serves the purpose of improving the guidance of the exiting steel melt in the direction of the mouth orifices 38 of the risers. However, the bores which are allocated to the edge-side outflow orifices 37′ can also extend in particular along the same axis with respect to the risers 13 and this is merely a question of the surface-placement of the outflow orifices 37, 37′ relative to the mouth orifices 32 of the risers.

Where a spatially separated transfer of partial flows of steel melt is guaranteed on the one hand into a central region of the casting mould 33 via the bar 18 and on the other hand in a peripheral region, namely the risers, numerous modifications of the functional principle shown in FIG. 5 are feasible and are consequently arranged entirely to implement a casting process simultaneously in the form of a bottom casting and top casting by virtue of the fact that for these two casting process variations partial flows are formed which are introduced simultaneously into the casting mould.

1. Device for the alumino-thermic welding of two rail ends (2) by intermediate casting, having a casting mould (4) which surrounds the rail ends (2) in the region of a welding groove (3) and is open on the upperside, and having a reaction pot (1) which is intended to receive a fine-grain reaction mixture and for implementing the alumino-thermic reaction and is held above the casting mould (4), wherein the casting mould (4) comprises a central casting chamber which is defined by the rail ends (2), which are spaced apart from each other by the welding groove (3) and also by the facing walls of the casting mould (4), and to the side of the casting chamber said casting mould comprises at least one riser (13) which is permeably connected to the casting chamber only in the region of the rail foot (11) and wherein the reaction pot (1) is provided on the base-side with an outflow device which causes a steel melt to flow out of the reaction pot (1) and into the casting mould (4), characterised in that the outflow device and/or the casting mould (4) is/are configured in such a manner that the steel issuing out of the reaction pot (1) after completion of the alumino-thermic reaction and after separation of the steel and slag issues directly into the casting chamber in the form of a top casting and issues into the at least one riser (13) in the form of a bottom casting simultaneously.

2. Device as claimed in claim 1, characterised in that the outflow device of the reaction pot (1) is formed in a manner known per se by means of an outflow orifice (5) which is closed by virtue of an at least partially fusible closure body prior to the implementation of the alumino-thermic reaction.

3. Device as claimed in claim 2, characterised by a bar (18) which is located inside the casting chamber of the casting mould (4) and which serves to deflect the steel melt horizontally according to at least two partial flows, and by a flow divider which serves to subdivide each of the two partial flows into a first portion which is introduced above the rail head (9) of the rail ends (2) into the casting chamber and into a second portion which is introduced via the upper region of the riser (13) and in the region of the rail foot (11) into the casting chamber.

4. Device as claimed in claim 3, characterised in that the bar (18) is arranged and configured with the proviso that the steel melt impinges centrally upon the said bar and is deflected uniformly on both sides, namely perpendicularly with respect to the rail longitudinal direction.

5. Device as claimed in claim 4, characterised in that the bar (18) comprises on the upperside, i.e. in the region intended for guidance of the steel melt, two surface portions which are each inclined in the direction of the vertical end sides (23) of the bar.

6. Device as claimed in any one of claims 3 to 5, characterised in that in the casting chamber wall (22) facing the bar (18) in the direction of flow of the steel melt there is formed a recess (26) which is permeably connected to a riser (13) and that between the end side (23) of the bar (18), facing the wall (22) of the casting chamber, and the wall (22) there is formed a passage (25) which enables steel melt to flow through vertically into the casting chamber.

7. Device as claimed in any one of claims 3 to 6, characterised in that the side of the casting chamber wall (22) facing the bar (18) comprises a progression, which is inclined with respect to its underside and in the direction of a vertical longitudinal middle plane of the rail ends (2), at least into the region of the underside of the rail head (9) of the rail ends (2).

8. Device as claimed in any one of the preceding claims 3 to 7, characterised in that the quantity ratio of the two portions of each one of the said partial flows of the steel melt is fixed structurally by dimensioning the height position of the underside (30) of the recess (26) relative to the height position of the upperside (32) of the bar (18) in conjunction with the cross-sectional shapes of the passage (25) and the recess (26).

9. Device as claimed in any one of claims 3 to 8, characterised in that the quantity ratio of the two portions of each one of the said partial flows of the steel melt is fixed structurally by dimensioning the cross-sections of the passage (25) and the recess (26).

10. Device as claimed in claim 2, characterised by a bar which is located inside the casting chamber of the casting mould and by means of which the steel melt [lacuna] according to two first partial flows, which are deflected horizontally in the rail longitudinal direction and introduced subsequently above the rail head (9) of the rail ends (2) into the casting chamber, and according to two second partial flows which are introduced via the upper region of the risers (13) and in the region of the rail foot (11) into the casting chamber.

11. Device as claimed in claim 10, characterised in that the bar (18) is arranged and configured with the proviso that the steel melt impinges centrally thereon and is deflected uniformly in each case in the form of two partial flows in the rail longitudinal direction and two partial flows transversely with respect to the rail longitudinal direction.

12. Device as claimed in claim 11, characterised in that on the upperside, i.e. in the region intended for the guidance of the steel melt, the bar comprises a pyramid-like or truncated pyramid-like surface portions [sic] which are inclined in each case in the direction of the vertical end sides (23) of the bar (18) and the longitudinal sides of the bar (18).

13. Device as claimed in any one of the preceding claims 3 to 12, characterised in that a recess is disposed in the surface of the bar (18) and in particular in the region intended for contacting the steel melt.

14. Device as claimed in any one of the preceding claims 3 to 13, characterised in that the bar (18) is designed as a component which is separate from the casting mould (4) and can be inserted loosely therein.

15. Device as claimed in any one of claims 3 to 13, characterised in that the bar is formed in one piece with the casting mould.

16. Device as claimed in claim 1, characterised in that the outflow device of the reaction pot (35) consists of an outflow orifice (37), which is intended for the direct introduction of steel melt via the upper end of the casting chamber, and of at least one outflow orifice (37′) which is intended for the introduction of steel melt via the upper end of the at least one riser (13).

17. Device as claimed in claim 16, characterised in that the outflow orifices (37, 37′) are equipped with closure bodies which are formed with the proviso that the period of time required for melting after the commencement of the alumino-thermic reaction is the same for all of the outflow orifices (37, 37′).
